(19) United States
(12) Patent Application Publication
(10) Pub. No.: US 2008/0262144 A1
(43) Pub. Date: Oct. 23, 2008

(54) Aqueous, Radiation-Hardenable Resins, Method for the Production Thereof, and Use of the Same

(75) Inventors: Patrick Glockner, Haltern am See (DE); Lutz Mindach, Bochum (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GMBH, DUESSELDORF (DE)

(21) Appl. No.: 11/577,415

(22) PCT Filed: Aug. 23, 2003
(86) PCT No.: PCT/EP2005/054134

§ 371 Date: Jan. 29, 2008

(30) Foreign Application Priority Data
Oct. 19, 2004 (DE) 10 2004 050 77539

(51) Int. Cl. C08L 33/08; C08L 61/00; C08G 6/02; C08L 61/24; C08G 65/42; C08G 63/00; C08G 18/00

(52) U.S. Cl. 524/556; 525/471; 525/521; 525/509; 525/390; 524/592; 524/598; 524/611; 525/519; 525/397; 525/518; 525/391; 525/452; 525/450; 525/55; 525/523; 525/474; 524/599; 524/589

(57) ABSTRACT

The invention relates to aqueous, radiation-curable resins, to a process for preparing them, and to their use.

The invention relates to aqueous, radiation-curable resins, to a process for preparing them, and to their use in adhesives and coating materials.

Radiation-curable coating materials have gained increasingly in importance within recent years, one of the reasons for this being the low volatile organic compounds (VOC) content of these systems.

Within the coating material the film-forming components are of relatively low molecular weight and hence of low viscosity, thereby removing the need for high proportions of organic solvents. Durable coatings are obtained by the formation of a high molecular weight polymeric network following application of the coating material, network formation coming about as a result of crosslinking reactions initiated, for example by electron beams or UV light.

In spite of the low molecular weight of the film-forming components of the coating material the viscosity is often so high that spray application, for example, is impossible. The problem of high viscosity is circumvented through the use of radiation-curable polymers which have been dispersed in water, since then the processing viscosity is independent of the molecular weight of the polymer (K. Buysens, M. Tielemans, T. Randoux, Surface Coatings International Part A, 5 (2003), 179-186).

Ketone-aldehyde resins are used in coating materials, for example, as additive resins in order to enhance certain properties such as initial drying rate, gloss, hardness or scratch resistance.

Ketone-aldehyde resins normally possess hydroxyl groups and can therefore be crosslinked only with, for example polyisocyanates or amine resins. These crosslinking reactions are normally initiated and/or accelerated thermally.

For radiation-initiated crosslinking reactions by cationic and/or free-radical reaction mechanisms, the ketone-aldehyde resins are unsuitable.

The ketone-aldehyde resins are therefore normally used in radiation-curable coating systems as, for example, a film-forming, but not a crosslinking, additive component. Coatings of this kind, owing to the uncrosslinked fractions, often possess low resistance to gasoline, chemicals or solvents, for example.

DE 23 45 624, EP 736 074, DE 28 47 796, DD 24 0318, DE 24 38 724, and JP 09143396 describe the use of ketone-aldehyde resins and ketone resins, cyclohexanone-formaldehyde resins for example, in radiation-curable systems. Radiation-induced crosslinking reactions of these resins have not been described.

EP 902 065 describes the use of non-radiation-curable resins formed from urea (derivatives), ketones or aldehydes as an additive component in a mixture with radiation-curable resins.

DE 24 38 712 describes radiation-curing printing inks comprising film-forming resins, ketone resins and ketone-formaldehyde resins, and polymerizable components such as polyfunctional acrylate esters of polyhydric alcohols. To the skilled worker it is obvious that a radiation-induced crosslinking reaction of the modified ketone-aldehyde resins and ketone resins can occur only through the use of unsaturated fatty acids. It is known, however, that resins with a high oil content tend toward unwanted yellowing.

U.S. Pat. No. 4,070,500 describes the use of non-radiation-curable ketone-formaldehyde resins as a film-forming component in radiation-curable inks.

Water-dispersible condensation products or derivatives thereof are described in DE 196 43 704, EP 838 485, EP 498 301, DE 25 42 090, DE 31 44 673 and EP 154 835. There use in applications where the crosslinking is initiated by radiation is not described.

DE 34 06 473 and DE 34 06 474 or EP 154 835 describe aqueous dispersions of urea-aldehyde resins, ketone resins or ketone-aldehyde resins using organic protective colloids.

Besides the disadvantage that protective colloids may adversely affect properties such as corrosion resistances in the subsequent application, these resins are not radiation-crosslinkable. EP 594 038 describes likewise non-radiation-curable, aqueous urea-formaldehyde resins.

In all publications relating to aqueous condensation products there is no description of a use in radiation-curable systems. Also there is no description of how water-dispersible resins can be obtained that are crosslinkable by UV light or electron beams.

It was an object of the present invention to carry out chemical, hydrophilic modification of hydroxyl-containing ketone, ketone-aldehyde, urea-aldehyde, and phenolic resins, and also their hydrogenated derivatives, in such a way that they are soluble or dispersible in water and can be converted into a polymeric network by means of radiation in the presence of a suitable additive. The intention was also to find a process for preparing them. The aqueous resin dispersions ought to be stable to hydrolysis and stable on storage.

Surprisingly it has been possible to achieve this object by reacting hydroxyl-containing ketone, ketone-aldehyde, urea-aldehyde, and phenolic resins and also the hydrogenated derivatives with polycarboxylic acids and/or hydrophilically modified (poly)isocyanates and also with a component containing at least one ethylenically unsaturated moiety and at the same time at least one moiety which is reactive toward the resins.

Following neutralization, if needed, and addition of water, the ketone, ketone-aldehyde, urea-aldehyde, and phenolic resins, and also their hydrogenated derivatives, that have been modified in this way give rise to stable aqueous dispersions which can be converted into polymeric networks by irradiation in the presence of an additive such as a photoinitiator, for example, if desired in the presence of a photosensitizer.

The aqueous systems of the invention are stable to hydrolysis, stable on storage, and contain no disruptive adjuvants in the form, for example, of emulsifiers or protective colloids.

The invention provides aqueous, radiation-curable resin dispersions essentially comprising the reaction product of
A) at least one hydroxyl-containing ketone resin, ketone-aldehyde resin, urea-aldehyde resin, phenolic resin or hydrogenated derivative thereof,
   and
B) at least one compound containing at least one hydrophilic and/or potentially hydrophilic group,
   and
C) at least one compound containing at least one ethylenically unsaturated moiety with at the same time at east one moiety that is reactive toward A) and/or B).

The invention also provides aqueous, radiation-curable resins dispersions obtained by a polymer-analogous reaction of
A) at least one hydroxyl-containing ketone resin, ketone-aldehyde resin, urea-aldehyde resin, phenolic resin or hydrogenated derivative thereof,
   and
B) at least one compound containing at least one hydrophilic and/or potentially hydrophilic group,
   and
C) at least one compound containing at least one ethylenically unsaturated moiety with at the same time at least one moiety that is reactive toward A) and/or B)
   and subsequent combination on the neutralized or unneutralized resin with water.

Ketones suitable for preparing the ketone resins and ketone-aldehyde resins (component A)) include all ketones, especially acetone, acetophenone, methyl ethyl ketone, heptan-2-one, pentan-3-one, methyl isobutyl ketone, cyclopentanone, cyclododecanone mixtures of 2,2,4- and 2,4,4-trimethylcyclopentanone, cycloheptanone and cyclooctanone, cyclohexanone and all alkyl-substituted cyclohexanones having one or more alkyl radicals containing a total of 1 to 8 carbon atoms, individually or in a mixture. Examples that may be mentioned of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone and 3,3,5-trimethylcyclohexanone.

Generally speaking, however, it is possible to use all of the ketones said in the literature to be suitable for ketone and ketone-aldehyde resin syntheses, generally all C—H-acidic ketones. Preference is given to ketone-aldehyde resins based on the ketones acetophenone, cyclohexanone, 4-tert-butylcyclohexanon, 3,3,5-trimethylcyclohexanone and heptanone, alone or in a mixture.

Suitable aldehyde components of the ketone-aldehyde resins (component A)) include, in principle, branched or unbranched aldehydes, such as formaldehyde, acetaldehyde, n-butyraldehyde and/or iso-butyraldehyde, valeraldehyde and dodecanal, for example. In general it is possible to use all of the aldehydes said in the literature to be suitable for ketone resin syntheses. It is preferred, however, to use formaldehyde, alone or in mixtures.

The required formaldehyde is normally employed as an aqueous or alcoholic (e.g., methanol or butanol) solution with a strength of approximately 20% to 40% by weight. Other forms of formaldehyde, such as the use of para-formaldehyde or trioxane, for example, are likewise possible. Aromatic aldehydes, such as benzaldehyde, may likewise be present in a mixture with formaldehyde.

Particularly preferred starting compounds used for ketone-aldehyde resins (component A)) are acetophenone, cyclohexanone, 4-tert-butylcyclohexanone, 3,3,5-trimethylcyclohexanone, and heptanone, alone or in a mixture, and formaldehyde.

The preparation and the monomers for urea-aldehyde resins (component A)) are described in EP 271 776:

as component A) use is made, inter alia, of urea-aldehyde resins using a urea of the general formula (i)

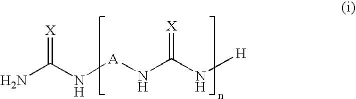

in which X is oxygen or sulfur, A is an alkylene radical, and n is 0 to 3, with 1.9 (n+1) to 2.2 (n+1) mol of an aldehyde of the general formula (ii)

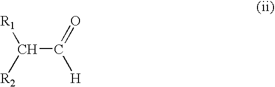

in which R₁ and R₂ are hydrocarbon radicals (e.g., alkyl, aryl and/or alkylaryl radicals) having in each case up 20 carbon atoms and/or formaldehyde.

Suitable ureas of the general formula (i) with n=0 are, for example, urea and thiourea, with n=1 methylenediurea, ethylenediurea, tetramethylenediurea and/or hexamethylenediurea, and mixtures thereof. Preference is given to urea.

Suitable aldehydes of the general formula (ii) are, for example, isobutyraldehyde, 2-methylpentanal, 2-ethylhexanal and 2-phenylpropanal, and mixtures thereof. Preference is given to isobutyraldehyde.

Formaldehyde can be used in aqueous form, which in part or as a whole may also include alcohols such as methanol or ethanol, for example, or else as paraformaldehyde and/or trioxane.

Generally speaking, suitable monomers are all those described in the literature for the preparation of aldehyde-urea resins.

Typical compositions are described, for example, in DE 27 57 220, DE-A 27 57 176 and EP 271 776.

Ketones suitable for preparing the carbonyl-hydrogenated ketone-aldehyde resins (component A)) include all ketones, especially acetone, acetophenone, methyl ethyl ketone, heptan-2-one, pentan-3-one, methyl isobutyl ketone, cyclopentanone, cyclododecanone mixtures of 2,2,4- and 2,4,4-trimethylcyclopentanone, cycloheptanone and cyclooctanone cyclohexanone and all alkyl-substituted cyclohexanones having one or more alkyl radicals containing a total of 1 to 8 carbon atoms, individually or in a mixture. Examples that may be mentioned of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone and 3,3,5-trimethylcyclohexanone.

Generally speaking, however, it is possible to use all of the ketones said in the literature to be suitable for ketone resin syntheses, generally all C—H-acidic ketones. Preference is given to carbonyl-hydrogenated ketone-aldehyde resins based on the ketones acetophenone, cyclohexanone, 4-tert-butylcyclohexanon, 3,3,5-trimethylcyclohexanone and heptanone, alone or in a mixture.

Suitable aldehyde components of the carbonyl-hydrogenated ketone-aldehyde resins (component A)) include, in principle, branched or unbranched aldehydes, such as formaldehyde, acetaldehyde, n-butyraldehyde and/or iso-butyraldehyde, valeraldehyde and dodecanal, for example. In general it is possible to use all of the aldehydes said in the literature to be suitable for ketone resin syntheses. It is preferred, however, to use formaldehyde, alone or in mixtures.

The required formaldehyde is normally employed as an aqueous or alcoholic (e.g., methanol or butanol) solution with a strength of approximately 20% to 40% by weight. Other forms of formaldehyde, such as the use of para-formaldehyde or trioxane, for example, are likewise possible. Aromatic aldehydes, such as benzaldehyde, may likewise be present in a mixture with formaldehyde.

Particularly preferred starting compounds used for component A) are carbonyl-hydrogenated resins formed from acetophenone, cyclohexanone, 4-tert-butylcyclohexanone, 3,3,5-trimethylcyclohexanone, and heptanone, alone or in a mixture, and formaldehyde.

The resins formed from ketone and aldehyde are hydrogenated with hydrogen in the presence of a catalyst at pressures of up to 300 bar. In the course of this hydrogenation, some of the carbonyl groups of the ketone-aldehyde resin are converted into secondary hydroxyl groups. Depending on he choice of catalyst for the hydrogenation and of further parameters such as hydrogen pressure, solvent, and temperature, for example, it is also possible for further moieties, such as aromatic structures, for example, which may be present in the resin as a result of the use of arylic ketones such as acetophenone and/or derivatives thereof, for example, also to be hydrogenated, in which case cycloaliphatic structures are obtained.

As component A) use is also made of ring-hydrogenated phenol-aldehyde resins of the novolak type, using the aldehydes such as formaldehyde, butyraldehyde or benzaldehyde, for example, preferably formaldehyde. To a minor extent it is possible to use non-hydrogenated novolaks, which then, however, possess lower light fastnesses.

Particularly suitable resins are ring-hydrogenated resins based on alkyl-substituted phenols. In general it is possible to use all of the phenols said in the literature to be suitable for phenolic resin syntheses.

Examples of suitable phenols that may be mentioned include phenol, 2- and 4-tert-butylphenol, 4-amylphenol, nonylphenol, and 4-tert-octylphenol, dodecylphenol, cresol, xylenols, and bisphenols. They can be used alone or in a mixture.

Very particular preference is given to using ring-hydrogenated, alkylsubstituted phenol-formaldehyde resins of the novolak type. Preferred phenolic resins are reaction products of formaldehyde and 2- and 4-tert-butylphenol, 4-amylphenol, nonylphenol, 2-, and 4-tert-octylphenol, and dodecylphenol.

Through the choice of hydrogenating conditions it is also possible for the hydroxyl groups to be hydrogenated, so that cycloaliphatic rings are formed. The ring-hydrogenated resins possess OH numbers of 50 to 450 mg KOH/g, preferably 75 to 350 mg KOH/g, more preferably from 100 to 300 mg KOH/g. The fraction of aromatic groups is below 50%, preferably below 30%, more preferably below 10%, by weight.

The hydrophilic modification is accomplished, for example, by reacting the hydroxy-functional resin A) with a (poly)isocyanate and/or mixtures of different (poly)isocyanates with compounds which in addition to the hydrophilic or potentially hydrophilic group—that is, groups of the kind which become hydrophilic only on neutralization—contain at least one function that is reactive toward isocyanate groups, such as hydroxyl groups or amino groups, for example. Examples of compounds of this kind for the hydrophilic modification of (poly)isocyanates are amino acids, hydroxysulfonic acids, aminosulfonic acids, and hydroxycarboxylic acids.

Preference is given to using dimethylolpropionic acid and/or 2-[(2-aminoethyl)amino]-ethanesulfonic acid or derivatives thereof (component B)).

The hydrophilic modification may also be performed with nonionic groups or with compounds which are already in neutralized form.

Suitable polyisocyanates for preparing B) are preferably polyisocyanates with a functionality of from two to four. Examples thereof are cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyl-1,8-octane diisocyanate (TIN), decane diisocyanate and triisocyanate, undecane diisocyanate and triisocyanate, dodecane diisocyanates and triisocyanates, isophorone diisocyanate (IPDI), bis(isocyanatomethylcyclohexyl)methane (H₁₂MDI), isocyanatomethylmethylcyclohexyl isocyanate, 2,5(2,6)-bis(isocyanato-methyl)bicyclo[2.2.1]heptane (NBDI), 1,3-bis-(isocyanatomethyl)cyclohexane (1,3-H₆-XDI) or 1,4-bis(isocyanatomethyl)cyclohexane (1,4-H₆-XDI), alone or in a mixture.

Another preferred class of polyisocyanates are the compounds prepared by trimerizing, allophanatizing, biuretizing and/or urethanizing the simple diisocyanates and having more than two isocyanate groups per molecule, examples being the reaction products of these simple diisocyanates, such as IPDI, HDI and/or HMDI for example, with polyhydric alcohols (e.g., glycerol, trimethylolpropane, pentaerythritol) and/or with polyfunctional polyamines, or the triisocyanurates obtainable by trimerizing the simple diisocyanates, such as IPDI, HDI and H₁₂MDI, for example.

Particularly preferred is a hydrophilically modified polyisocyanate (B) formed from dimethylolpropionic acid and/or 2-[(2-aminoethyl)amino]ethanesulfonic acid or derivatives thereof and IPDI and/or H₁₂MDI and/or HDI, in a molar ratio of 1:2.

It is, however, likewise possible as component B) to use polycarboxylic acids, polycarboxylic anhydrides, polycarboxylic esters and/or polycarboxylic halides, with a certain fraction of acid groups being retained. Examples are acid (derivative)s such as, for example, phthalic acid, maleic acid (anhydride), succinic acid (anhydride) 1,2-cyclohexanedicarboxylic acid (anhydride), pyromellitic acid (anhydride) and/or trimellitic anhydride. However, the stability to hydrolysis is lower in comparison to the above-described hydrophilicization possibilities.

It is also possible for nonionic hydrophilicization to take place, via polyethers, for example, which are reacted, for example, with abovementioned polyisocyanates and with component A).

Suitability as component C) is possessed by maleic anhydride, (meth)acrylic acid derivatives such as (meth)acryloyl chloride, glycidyl (meth)acrylate, (meth)acrylic acid and/or their low molecular weight alkyl esters and/or anhydrides, for example, alone or in a mixture. Radiation-curable resins can additionally be obtained by reacting component A) with B) and with isocyanates which possess an ethylenically unsaturated moiety, such as (meth)acryloyl isocyanate, α,α-dimethyl-3-isopropenylbenzyl isocyanate, (meth)acryloylalkyl isocyanate with alkyl spacers possessing one to 12, preferably 2 to 8, more preferably 2 to 6 carbon atoms, such as methacryloylethyl isocyanate, methacryloylbutyl isocyanate, for example. Reaction products of hydroxyalkyl (meth)acrylates whose alkyl spacers possess one to 12, preferably 2 to 8, more preferably 2 to 6 carbon atoms, and diisocyanates such as, for example, cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate such as 4-iso-cyanatomethyl-1,8-octane diisocyanate (TIN), decane diisocyanate and triisocyanate, undecane diisocyanate and triisocyanate, dodecane diisocyanates and triisocyanates, isophorone diisocyanate (IPDI), bis(isocyanatomethylcyclohexyl)methane (H₁₂MDI), isocyanato-methylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆-XDI) or 1,4-bis(isocyanato-methyl)cyclohexane (1,4-H₆-XDI), alone or in a mixture, have proven advantageous. Examples that may be mentioned are the reaction products—in a molar ratio of 1:1—of hydroxyethyl acrylate and/or hydroxyethyl methacrylate with isophorone diisocyanate and/or H₁₂MDI and/or HDI.

Another preferred class of polyisocyanates are the compounds prepared by trimerizing, allophanatizing, biuretizing and/or urethanizing the simple diisocyanates and having more than two isocyanate groups per molecule, examples being the reaction products of these simple diisocyanates, such as IPDI, HDI and/or HMDI for example, with polyhydric alcohols (e.g., glycerol, trimethylolpropane, pentaerythritol) and/or with polyfunctional polyamines, or the triisocyanurates obtainable by trimerizing the simple diisocyanates, such as IPDI, HDI and H₁₂MDI, for example.

It is also possible to replace part of component A) by a further hydroxy-functional polymers such as, for example, hydroxy-functional polyethers, polyesters, polyurethanes and/or polyacrylates. In this context it is possible directly to react mixtures of these polymers with components A), by a polymer-analogous method, with components B) and C). It has been found that initially it is also possible to prepare adducts of A) with, for example, hydroxy-functional polyethers, polyesters, polyurethanes and/or polyacrylates, using the stated di- and/or triisocyanates, and only then are these adducts reacted with components B) and C), by a polymer-analogous method. In contrast to the “pure” resins of the invention it is possible by this means to set properties more effectively, such as flexibility and hardness, for example. The further hydroxy-functional polymers generally posses molecular weights Mn of between 200 and 10 000 g/mol, preferably between 300 and 5000 g/mol.

The invention also provides a process for preparing aqueous, radiation-curable resin dispersions obtained by a polymer-analogous reaction of
A) at least one hydroxyl-containing ketone resin, ketone-aldehyde resin, urea-aldehyde resin, phenolic resin or hydrogenated derivative thereof,
   and
B) at least one compound containing at least one hydrophilic and/or potentially hydrophilic group,
   and
C) at least one compound containing at least one ethylenically unsaturated moiety with at the same time at least one moiety that is reactive toward A) and/or B)
   and subsequent combination of the neutralized or unneutralized resin with water.

The resins of the invention are prepared in the melt or in solution in a suitable organic solvent, which—if desired—can be separated off by distillation following the preparation.

Suitable auxiliary solvents used are low-boiling inert solvents which at least over wide ranges do not form a miscibility gap with water, which possess a boiling point under atmospheric pressure of below 100° C., and which can therefore, if desired, easily be separated off by distillation to a residual content of less than 2% by weight and in particular of less than 0.5% by weight, based on the finished dispersion or aqueous solution, and re-used. Examples of suitable such solvents include acetone, methyl ethyl ketone and tetrahydrofuran. Also suitable in principle are higher-boiling solvents such as n-butylglycol, di-n-butylglycol, and N-methylpyrrolidone, which then remain in the dispersion. If desired it is possible to use reactive diluents, i.e., compounds which possess a relatively low viscosity and at the same time are able to enter into radiation-initiated crosslinking reactions. These compounds likewise remain in the subsequent aqueous dispersion.

In one preferred embodiment a solution or melt of the hydroxyl-containing ketone, ketone-aldehyde, urea-aldehyde or phenolic resins or hydrogenated derivatives thereof, A), is admixed with the compound which contains at least one ethylenically unsaturated moiety and at the same time at least one moiety that is reactive toward A) and/or B) (component C)), if desired in the presence of a suitable catalyst.

It has proven advantageous to react 1 mol of component A)—based on Mₙ—with 0.5 to 15 mol, preferably 1 to 10 mol, especially 2 to 8 mol of the unsaturated compound (component C).

In parallel with this it is possible to prepare component B)—for example, an adduct of 2 mol of diisocyanate and 1 mol of dimethylolpropionic acid and/or 2-[(2-aminoethyl)amino]-ethanesulfonic acid or derivatives thereof—using, if desired, a suitable solvent and a suitable catalyst.

The separately prepared products are united and reacted.

It has proven advantageous to react 1 mol of the reaction product of component A) and C)—based on Mₙ—with 0.25 to 1.5 mol, more preferably 0.5 to 1 mol, of component B).

The temperature of the reaction is chosen in accordance with the reactivity of the components to one another. Temperatures which have proven appropriate for all reaction steps are between 30 and 245° C., preferably between 50 and 140° C.

If desired it is possible to use a suitable catalyst for preparing the resins of the invention. Suitable compounds are all those known in the literature which accelerate an OH—NCO reaction, such as diazabicyclooctane (DABCO) and/or metal compounds such as dibutyltin dilaurate (DBTL) for example.

The reaction can be stopped, if desired, by adding an amine or an alcohol. Depending on the identity of this component it is possible to vary further properties such as, for example, the compatibility with other raw materials, examples being pigments.

If necessary it is possible first to carry out neutralization with a suitable neutralizing agent and then to disperse the neutralized reaction product in water. Alternatively dispersion can take place directly in a water/neutralizing agent mixture. Water-dilutable, water-dispersible or water-soluble products are obtained.

The potentially hydrophilic groups of the resins prepared in accordance with the invention can be neutralized using organic and/or inorganic bases, such as ammonia or organic amines, for example. Preference is given to using primary, secondary and and/or tertiary amines, such as ethylamine, propylamine, dimethylamine, dibutylamine, cyclohexylamine, benzylamine, morpholine, piperidine and triethanolamine. Particular preference is given to volatile, tertiary amines, especially dimethylethanolamine, diethylethanolamine, 2-dimethylamino-2-methyl-1-propanol, triethylamine, tripropylamine and tributylamine in the case of anionic potential groups. So-called cationic potential ionogenic groups can be neutralized using organic and/or inorganic acids, such as acetic acid, formic acid, phosphoric acid, hydrochloric acid, etc.

The degree of neutralization is guided by the amount of neutralizable groups in the hydrophilically modified resin, and amounts preferably to 50% to 130% of the neutralization amount necessary for stoichiometric neutralization.

Prior to dispersion, the reaction product of A), B), and C) can be combined, if desired, with further hydrophilically adjusted and/or non-hydrophilically adjusted resins and/or with further components, and then dispersed jointly, with, for example, acrylated polyesters, polyacrylates, polyesterurethanes, epoxy acrylates and/or polyether acrylates and also alkyd resins, ketone-formaldehyde resins, ketone resins and/or unsaturated polyesters.

The solvent that may be present can be separated off if desired after the end of reaction, in which case a solution or dispersion of the product of the invention in water is generally obtained.

The aqueous dispersions of the invention are suitable for use as main, base or additive component in aqueous radiation-curing coating materials, adhesives, inks, including printing inks, polishes, glazes, pigment pastes, filling compounds, cosmetics articles, sealants and/or insulants, since they are distinguished by rapid initial-drying rates and through-volume drying rates, high blocking resistances, owing to their high glass transition temperature, and very good pigment wetting properties, even in the case of organic pigments which are difficult to wet.

In the presence of suitable photoinitiators, and in the presence if desired of suitable photosensitizers, these resins, after the water has been evaporated off, can be converted by irradiation into polymeric, insoluble networks, which, depending on the level of ethylenically unsaturated groups, give rise to elastomers or thermosets.

In particular they are used
as a main, base or additive component in aqueous, radiation-curing coating materials, adhesives, inks, including printing inks, polishes, glazes, pigment pastes, filling compounds, cosmetics articles, sealants and/or insulants;
as a main, base or additive component in aqueous, radiation-curing filling compounds, primers, surfacers, basecoat, topcoat, and clearcoat materials;
for the coating of metals, wood, wood veneers, wood laminates, plastics, paper, paperboard, cardboard, inorganic substances such as ceramic, stone, concrete and/or glass, textiles, fibers, woven materials, leather;
as a main, base or additive component in aqueous, radiation-curing coating materials, adhesives, inks, including printing inks, polishes, glazes, pigment pastes, filling compounds, cosmetics articles, sealants and/or insulants, there being present further oligomers and/or polymers selected from the group consisting of polyurethanes, polyesters, polyacrylates, polyethers, polyolefins, natural resins, epoxy resins, silicone oils, silicone resins, amine resins, fluoro polymers, and derivatives thereof, alone or in combination;
as a main, base or additive component in aqueous, radiation-curing coating materials, adhesives, inks, including printing inks, polishes, glazes, pigment pastes, filling compounds, cosmetics articles, sealants and/or insulants, there being present auxiliaries and additives selected from inhibitors, organic solvents, which if desired contain unsaturated moieties, surface-active substances, oxygen scavengers and/or free-radical scavengers, catalysts, light stabilizers, color brighteners, photosensitizers and photoinitiators, additives for influencing rheological properties such as thixotropic agents and/or thickeners, for example, flow control agents, antiskinning agents, defoamers, plasticizers, antistats, lubricants, wetting agents, dispersants, preservatives, examples of which include fungicides and/or biocides, thermoplastic additives, dyes, pigments, matting agents, flame retardants, internal release agents, fillers and/or blowing agents.

The invention also provides the coated articles produced with compositions comprising the dispersions of the invention.

The example below is intended to illustrate the invention but not to restrict its scope of application:

### 1) Preparation of a Hydrophilically Modified Polyisocyanate (Component B)):

A mixture of 134 g of dimethylolpropionic acid, 380 g of acetone and 6 g of a 10% strength by mass solution of dibutyltin dilaurate in acetone is admixed with stirring with 444 g of isophorone diisocyanate at a rate such that the exothermic reaction remains readily manageable. The mixture is heated to 60° C. and this temperature is maintained until the NCO number is 9.2%. The batch is then cooled to room temperature.

2) Reaction of a Resin A) with the Unsaturated Compound C):

1267 g of a carbonyl group-hydrogenated acetophenone-formaldehyde resin (Kunstharz SK, Degussa AG) are dissolved in 1450 g of acetone, and 2.2 g of dibutyltin dilaurate are added. Then 919 g of a 1:1 reaction product of IPDI and hydroxyethyl acrylate in the presence of 0.2% (based on resin) of 2,6-bis(tert-butyl)-4-methylphenol (Ralox BHT, Degussa AG) are added. The batch is held with stirring at 60° C. until an NCO number below 0.2% is reached.

### 3) Reaction of Adducts of 1) and 2):

The two solutions of 1) and 2) are combined and held at 60° C. until an NCO number below 0.3% is reached.

### 4) Conversion to the Aqueous Phase:

250 g of the adduct from stage 3) are admixed at 30° C. with 4.7 g of dimethylaminoethanol and the system is then dispersed with vigorous stirring (12 m/s peripheral speed) with 361 g of demineralized water. After about 10 minutes 4.6 g of Darocur 1173 are added, with moderate stirring, and the acetone is removed from the mixture at an elevated temperature and under a gentle vacuum.

This gives a slightly turbid dispersion which is stable on storage and has a pH of 8.8, a solids fraction of 32%, and a viscosity of around 300 mPas.

The dispersion is combined 1:1 with a polyurethane dispersion and the dispersion mixture is applied to a glass plate or a metal Bonder panel, and the solvent is evaporated at elevated temperature (30 min, 80° C.). Thereafter the films are cured by means of UV light (medium-pressure mercury lamp, 70 W/optical filter 350 nm) for about 12 seconds.

The films are resistant to super-grade gasoline and to methyl ethyl ketone.

Adhesion to steel panel (DIN 53151): 0
Buchholz indentation hardness (DIN 53153): 83
Erichsen cupping (DIN 53156):>9.3 mm König pendulum hardness (DIN 53157): 123 s

1. An aqueous, radiation-curable resin dispersion essentially comprising the reaction product of
A) at least one hydroxyl-containing ketone resin, ketone-aldehyde resin, urea aldehyde resin, phenolic resin or hydrogenated derivative thereof,
and
B) at least one compound containing at least one hydrophilic and/or potentially hydrophilic group,
and
C) at least one compound containing at least one ethylenically unsaturated moiety with at the same time at least one moiety that is reactive toward A) and/or B).

2. An aqueous, radiation-curable resin dispersion obtained by a polymer-analogous reaction of
A) at least one hydroxyl-containing ketone resin, ketone-aldehyde resin, urea-aldehyde resin, phenolic resin or hydrogenated derivative thereof,
and
B) at least one compound containing at least one hydrophilic and or potentially hydrophilic group,
and
C) at least one compound containing at least one ethylenically unsaturated moiety with at the same time at least one moiety that is reactive toward A) and/or B)
and subsequent combination of the neutralized or unneutralized resin with water.

3. The aqueous, radiation-curable resin dispersion according to claim 2 obtained by a polymer-analogous reaction of
A) at least one hydroxyl-containing ketone resin, ketone-aldehyde resin, urea-aldehyde resin, phenolic resin or hydrogenated derivative thereof,
and
B) at least one compound containing at least one hydrophilic and/or potentially hydrophilic group,
and
C) at least one compound containing at least one ethylenically unsaturated moiety with at the same time at least one moiety that is reactive toward A) and/or B),
component A) first being reacted polymer-analogously with component C) and then with component B), and this being followed by the combination of the neutralized or unneutralized resin with water.

4. The aqueous, radiation-curable resin dispersion according to claim 1, essentially comprising
A) at least one hydroxyl-containing ketone resin, ketone-aldehyde resin, urea aldehyde resin, phenolic resin or hydrogenated derivative thereof,
and
B) at least one compound containing at least one hydrophilic or potentially hydrophilic group,
and
C) at least one compound containing at least one ethylenically unsaturated moiety with at the same time at least one moiety that is reactive toward A) an or B),
and at least one further hydroxy-functionalized polymer.

5. The aqueous, radiation-curable resin dispersion according to claim 1,
wherein
C—H-acidic ketones are used in component A).

6. The aqueous, radiation-curable resin dispersion according to claim 1,
wherein
ketones selected from acetone, acetophenone, methyl ethyl ketone, heptan-2-one, pentan-3-one, methyl isobutyl ketone, cyclopentanone, cyclododecanone, mixtures of 2,2,4- and 2,4,4-trimethylcyclopentanone, cycloheptanone, cyclooctanone, and cyclohexanone, as starting compounds, alone or in a mixture, are used in the ketone-aldehyde resins and/or the carbonyl-hydrogenated ketone-aldehyde resins of component A).

7. The aqueous, radiation-curable resin dispersion according to claim 1,
wherein
alkyl-substituted cyclohexanones having one or more alkyl radicals containing in total 1 to 8 carbon atoms, alone or in a mixture, are used in the ketone-aldehyde resins and/or the carbonyl-hydrogenated ketone-aldehyde resins of component A).

8. The aqueous, radiation-curable resin dispersion according to claim 7,
wherein
4-tert-amylcyclohexanone, 2-sec-butylcyclohexanone, 2-tert-butylcyclohexanone, 4-tert-butylcyclohexanone, 2-methylcyclohexanone and 3,3,5-trimethylcyclohexanone are used.

9. The aqueous, radiation-curable resin dispersion according to claim 1,
wherein
cyclohexanone, 4-tert-butylcyclohexanone, 3,3,5-trimethylcyclohexanone and heptanone, alone or in a mixture, are used in the ketone-aldehyde resins and/or the carbonyl-hydrogenated ketone-aldehyde resins of component A).

10. The aqueous, radiation-curable resin dispersion according to claim 1,
wherein
formaldehyde, acetaldehyde, n-butyraldehyde and/or iso-butyraldehyde, valeraldehyde, and dodecanal, alone or in a mixture, is or are used as aldehyde component of the ketone-aldehyde resins and/or the carbonyl-hydrogenated ketone-aldehyde resins in component A).

11. The aqueous, radiation-curable resin dispersion according to claim 10,
wherein
formaldehyde and/or para-formaldehyde and/or trioxane are used.

12. The aqueous, radiation-curable resin dispersion according to claim 1,
wherein
hydrogenation products of the resins formed from acetophenone, cyclohexanone, 4-tert-butylcyclohexanone, 3,3,5-trimethylcyclohexanone, and heptanone, alone or in a mixture, and formaldehyde are used as component A).

13. The aqueous, radiation-curable resin dispersion according to claim 1,
wherein
the aldehydes formaldehyde, butyraldehyde and/or benzaldehyde are used in the ring-hydrogenated phenol-aldehyde resins of component A).

14. The aqueous, radiation-curable resin dispersion according to claim 1,
wherein
non-hydrogenated phenol-aldehyde resins are used to a minor extent.

15. The aqueous, radiation-curable resin dispersion according to claim 1,
wherein
ring-hydrogenated resins based on alkyl-substituted phenols are used in component A).

16. The aqueous, radiation-curable resin dispersion according to claim 15,
wherein
4-tert-butylphenol, 4-amylphenol, nonylphenol, tert-octylphenol, dodecylphenol, cresol, xylenols and bisphenols, alone or in mixtures, are used.

17. The aqueous, radiation-curable resin dispersion according to claim 1,
wherein
urea-aldehyde resins prepared by reacting a urea of the general formula (i) 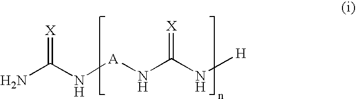
in which X is oxygen or sulfur, A is an alkylene radical, and n is 0 to 3, with 1.9 (n+1) to 2.2 (n+1) mol of an aldehyde of the general formula (ii) 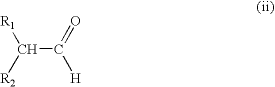
in which R₁ and R₂ are hydrocarbon radicals having in each case up 20 carbon atoms and/or with
formaldehyde are used as component A).

18. The aqueous, radiation-curable resin dispersion according to claim 1, wherein urea-aldehyde resins prepared using urea and thiourea, methylenediurea, ethylenediurea, tetramethylenediurea and/or hexamethylenediurea or mixtures thereof are used as component A).

19. The aqueous, radiation-curable resin dispersion according to claim 1, wherein urea-aldehyde resins prepared using isobutyraldehyde, formaldehyde, 2-methylpentanal, 2-ethylhexanal and 2-phenylpropanal or mixtures thereof are used as component A).

20. The aqueous, radiation-curable resin dispersion according to claim 1, wherein urea-aldehyde resins prepared using urea, isobutyraldehyde, and formaldehyde are used as component A).

21. The aqueous, radiation-curable resin dispersion according to claim 1, wherein component B) is a dicarboxylic and/or polycarboxylic acid or is prepared by reacting tertiary amino alcohols, amino carboxylic acids, hydroxy sulfonic acids, amino sulfonic acids and/or hydroxy carboxylic acids and/or polyethers with isocyanates having a functionality of from two to four.

22. The aqueous, radiation-curable resin dispersion according to claim 1, wherein component B) is prepared by reacting dimethylolpropionic acid and/or 2-[(2-aminoethyl)amino]ethanesulfonic acid or derivatives thereof such as, for example, the sodium salt of 2-[2-aminoethyl)amino]ethanesulfonic acid and/or polyethers having a molecular weight range between 300 and 5000 g.mol⁻¹ with IPDI, HDI, TMDI and/or H₁₂MDI.

23. The aqueous, radiation-curable resin dispersion according to claim 1, wherein maleic acid is used as component C).

24. The aqueous, radiation-curable resin dispersion according to claim 1, wherein (meth)acrylic acid and/or derivatives are used as component C).

25. The aqueous, radiation-curable resin dispersion according to claim 1, wherein (meth)acryloyl chloride, glycidyl (meth)acrylate, (meth)acrylic acid and/or the low molecular weight alkyl esters and/or anhydrides thereof, alone or in a mixture, are used as component C).

26. The aqueous, radiation-curable resin dispersion according to claim 1, wherein isocyanates which possess an ethylenically unsaturated moiety, preferably (meth)acryloyl isocyanate, α,α-dimethyl-3-isopropenylbenzyl isocyanate, (meth)acryloylalkyl isocyanate with alkyl spacers possessing 1 to 12, preferably 2 to 8, more preferably 2 to 6 carbon atoms, preferably methacryloylethyl isocyanate and methacryloylbutyl isocyanate, are used as component C).

27. The aqueous, radiation-curable resin dispersion according to claim 1, wherein reaction products of hydroxyalkyl (meth)acrylates, whose alkyl spacers possess 1 to 12, preferably 2 to 8, more preferably 2 to 6 carbon atoms, with diisocyanates are used as component C).

28. The aqueous, radiation-curable resin dispersion according to claim 1, wherein aliphatic and/or cycloaliphatic diisocyanates are used.

29. The aqueous, radiation-curable resin dispersion according to claim 1, wherein polyisocyanates prepared by trimerizing, allophanatizing, biuretizing and/or urethanizing simple diisocyanates are used to prepare component C).

30. The aqueous, radiation-curable resin dispersion according to claim 1, wherein the reaction products in a molar ratio of 1:1 of hydroxyethyl acrylate and/or hydroxyethyl methacrylate with isophorone diisocyanate and/or H₁₂MDI and or HDI and/or TMDI are used as component C).

31. The aqueous, radiation-curable resin dispersion according to claim 1, wherein 1 mol of component A), based on Mₙ, and 0.5 to 15 mol, preferably 1 to 10 mol, especially 2 to 8 mol of the unsaturated compound C) are used and wherein 1 mol of the reaction product of component A) and C)—based on Mₙ—with 0.25 to 1.5 mol, more preferably 0.5 to 1 mol, of component B) are reacted.

32. The aqueous, radiation-curable resin dispersion according to claim 1, characterized by
a) a nonvolatiles content of 20% to 60%
b) an organic solvent content of 0 to 20% by weight
c) a pH between 5.0 and 9.5
d) a viscosity at 20° C. of 20 to 5000 mPas.

33. The aqueous, radiation-curable resin dispersion according to claim 1, wherein at least some of any potentially ionic groups present in the resin have been neutralized.

34. The aqueous, radiation-curable resin dispersion according to claim 1, wherein an amine, an acid and/or an inorganic alkali solution is used for neutralization, depending on the identity of the potentially ionic group.

35. The aqueous, radiation-curable resin dispersion according to claim 33, wherein the degree of neutralization is between 0.5 and 1.3, preferably between 0.5 and 1.1, more preferably between 0.6 and 1.0.

36. The aqueous, radiation-curable resin dispersion according to claim 1, wherein polyurethanes, polyesters, polyacrylates, polyethers, polyolefins, natural resins, epoxy resins, silicone oils, silicone resins, amine resins, fluoro polymers, and derivatives thereof, alone or in combination, are used as further hydroxy-functionalized polymers.

37. The aqueous, radiation-curable resin dispersion according to claim 1, where mixtures of the further polymers with the hydroxyl-containing ketone, ketone-aldehyde, urea-aldehyde and/or phenolic resins and/or hydrogenated derivatives thereof are reacted polymer-analogously with components B) and C).

38. The aqueous, radiation-curable resin dispersion according to claim 1, where first adducts of the hydroxyl-containing ketone, ketone-aldehyde, urea-aldehyde and/or phenolic resins or hydrogenated derivatives thereof with the further polymers are prepared, using suitable di- and/or triisocyanates, and only then are said adducts reacted polymer-analogously with components B) and C).

39. A process for preparing an aqueous, radiation-curable resin dispersion obtained by a polymer-analogous reaction of
A) at least one hydroxyl-containing ketone resin, ketone-aldehyde resin, urea-aldehyde resin, phenolic resin or hydrogenated derivative thereof
and
B) at least one compound containing at least one hydrophilic or potentially hydrophilic group,
and
C) at least one compound containing at least one ethylenically unsaturated moiety with at the same time at least one moiety that is reactive toward A) and/or B)
and subsequent combination of the neutralized or unneutralized resin with water.

40. A process for preparing an aqueous, radiation-curable resin dispersion obtained by a polymer-analogous reaction of
A) at least one hydroxyl-containing ketone resin, ketone-aldehyde resin, urea-aldehyde resin, phenolic resin or hydrogenated derivatives thereof
and
B) at least one compound containing at least one hydrophilic or potentially hydrophilic group,
and
C) at least one compound containing at least one ethylenically unsaturated moiety with at the same time at least one moiety that is reactive toward A) and/or B)
and at least one further hydroxy-functionalized polymer, and subsequent combination of the neutralized or unneutralized resin with water.

41. The process according to claim 39, wherein a catalyst is used.

42. The process according to claim 39, wherein reaction is carried out in the melt or in a solvent, which may also possess unsaturated moieties.

43. The process according to claim 39, wherein the solvent, used if desired, can be separated off after the end of reaction.

44. (canceled)

45. The process according to claim 39, wherein the solution or melt of component A) is admixed with component C), if desired in the presence of a suitable catalyst, and then component B) is added.

46. The process according to claim 39, wherein the solution or melt of component A) and the hydroxy-functional polymer is admixed with component C), if desired in the presence of a suitable catalyst, and then component B) is added.

47. The process according to claim 42, wherein the solution or melt of component A) and the hydroxy-functional polymer is admixed with a di- and/or trifunctional isocyanate, and a hydroxy-functional preadduct is prepared, and then the preadduct is admixed with component C), if desired in the presence of a suitable catalyst, and then component B) is added.

48. The process according to claim 39, wherein reaction takes place at temperatures between 30 and 245° C., preferably between 50 and 140° C.

49. The process according to claim 39, wherein polyethers, polyesters, polyurethanes and/or polyacrylates are used as hydroxy-functionalized polymers.

50. The use of an aqueous, radiation-curable dispersion according to claim 1 as a main, base or additive component in aqueous, radiation-curing coating materials, adhesives, inks, including printing inks, polishes, glazes, pigment pastes, filling compounds, cosmetics articles, sealants and/or insulants.

51. The use of an aqueous, radiation-curable dispersion according to claim 1 as a main, base or additive component in aqueous, radiation-curing filling compounds, primers, surfacers, basecoat, topcoat, and clearcoat materials.

52. The use of an aqueous, radiation-curable dispersion according to claim 1 for coating metals, wood, wood veneers, wood laminates, plastics, paper, paperboard, cardboard, inorganic substances such as ceramic, stone, concrete and/or glass, textiles, fibers, woven materials, leather.

53. The use of an aqueous, radiation-curable dispersion according to claim 1 as a main, base or additive component in aqueous, radiation-curing coating materials, adhesives, inks, including printing inks, polishes, glazes, pigment pastes, filling compounds, cosmetics articles, sealants and/or insulants, wherein further oligomers and/or polymers are present.

54. The use of an aqueous, radiation-curable dispersion according to claim 1 as a main, base or additive component in aqueous, radiation-curing coating materials, adhesives, inks, including printing ins, polishes, glazes, pigment pastes, filling compounds, cosmetics articles, sealants and/or insulants, wherein further oligomers an or polymers are present selected from the group consisting of polyurethanes, polyesters, polyethers, polyacrylates, natural resins, alkyd resins, cellulose ethers, cellulose derivatives, polyvinyl alcohols and derivatives, polyolefins, rubbers, maleate resins, phenol/urea-aldehyde resins, amino resins (e.g., melamine resins, benzoguanamine resins), epoxy acrylates, epoxy resins, silicic esters and alkali silicates (e.g., waterglass), silicone oils, silicone resins, amine resins, fluoro polymers and their derivatives, alone or in combination.

55. The use of an aqueous, radiation-curable dispersion according to claim 1 as a main, base or additive component in aqueous, radiation-curing coating materials, adhesives, inks, including printing inks, polishes, glazes, pigment pastes, filling compounds, cosmetics articles, sealants and/or insulants, wherein auxiliaries and additives are present.

56. The use of an aqueous, radiation-curable dispersion according to claim 1 as a main, base or additive component in aqueous, radiation-curing coating materials, adhesives, inks, including printing inks, polishes, glazes, pigment pastes, filling compounds, cosmetics articles, sealants and/or insulants, wherein auxiliaries and additives, alone or in a mixture, are used which are selected from the group consisting of inhibitors, organic solvents, which if desired contain unsaturated moieties, surface-active substances, oxygen scavengers and/or free-radical scavengers, catalysts, light stabilizers, color brighteners, photosensitizers and photoinitiators, additives for influencing rheological properties such as thixotropic agents and/or thickeners, for example, flow control agents, antiskinning agents, defoamers, plasticizers, antistats, lubricants, wetting agents, dispersants, preservatives, examples of which include fungicides and/or biocides, thermoplastic additives, dyes, pigments, matting agents, flame retardants, internal release agents, fillers and/or blowing agents.

57. A coated article produced with a composition composing an aqueous, radiation-curable dispersion according to claim 1.
